(19) United States
(12) Patent Application Publication
(10) Pub. No.: US 2017/0317500 A1
(43) Pub. Date: Nov. 2, 2017

(54) SYSTEM AND METHOD OF SENSING AND ISOLATING A GROUND FAULT IN A DC-TO-AC POWER CONVERSION SYSTEM

(71) Applicant: Eaton Corporation, Cleveland, OH (US)

(72) Inventors: Dilip Kumar, Wagholi (IN); Armen Baronian, Toronto (CA)

(21) Appl. No.: 15/139,909

(22) Filed: Apr. 27, 2016

(51) Int. Cl. H02J 3/38; H02M 1/08; H02M 7/44; H02M 1/00

(52) U.S. Cl. CPC H02J 3/383; H02M 7/44; H02M 1/08; H02M 2001/0009

(57) ABSTRACT

A DC-to-AC power conversion system includes DC power source assemblies each having a plurality of DC power sources and a combiner coupled to the DC output from the DC power source assemblies. A power inverter is coupled to a DC output of the combiner and configured to invert the DC output to an AC output. The system includes a controller programmed to identify a potential ground fault using current data received from a ground current sensor provided on a ground conductor. After identifying the faulty DC power source using sensed current data received from a current sensor provided on at least one of the positive conductors and the negative conductors, the controller opens the DC breaker switches on a positive conductor and a negative conductor of the combiner to disconnect the faulty DC power source assembly from the power inverter.

### BACKGROUND OF THE INVENTION

Embodiments of the invention relate generally to DC-to-AC power conversion systems, more particularly, to a power system that includes DC power sources in the form of PV arrays or DC storage batteries and that incorporates a current sensor system that monitors for ground faults within the power conversion system. The power conversion system also includes one or more DC breakers that are controllable to selectively isolate a detected ground fault.

PV power systems are power systems that employ a plurality of solar modules to convert sunlight into electricity. PV systems include multiple components, including photovoltaic modules, mechanical and electrical connections and mountings, and means of regulating or modifying the electrical output. One common arrangement in PV systems is for several PV modules to be connected in series to form a PV string, with multiple PV strings in a PV system then being combined in parallel to aggregate the current in a PV array. Photovoltaic (PV) cells generate direct current (DC) power, with the level of DC current being dependent on solar irradiation and the level of DC voltage dependent on temperature. When alternating current (AC) power is desired, an inverter is used to convert the DC energy into AC energy, such as AC energy suitable for transfer to a power grid.

PV power systems also include a balance-of-system comprising DC switching and protection devices, combiner boxes, circuit breakers, disconnect switches, and contactors. Combiner boxes aggregate the DC power from the PV strings and provide a parallel connection point (i.e., a common bus) for the PV strings, with the combiner box providing overcurrent protection and isolation. Each combiner box typically includes a fuse for each positive string wire, and the fuse(s) feed a positive bus bar. Negative wires are also collected within the combiner box to form a negative bus. Conductors sized to handle the combined current and voltage produced at the combiner boxes carry DC power to a master combiner (which may also be regarded as an array combiner or a re-combiner), where combiner box outputs are combined in parallel. Output from one or more master combiners travels through large conductors to a central inverter, and DC power from the master combiner is output as AC power from the inverter. The inverter output is fed to a transformer that converts the output AC voltage to the transmission voltage of the utility. Supplemental DC power can also be provided to a utility grid via a system of utility-scale DC storage batteries that are coupled to an inverter in a similar manner as the PV modules described above.

PV systems and grid-tied DC storage battery systems are at risk of developing faults due to the very large number of connections within the system. Thousands of current-carrying conductors and associated connections can exist in a PV system or grid-tied storage battery system, giving thousands of possible locations for faults to develop. A ground fault is one of the most common faults in PV systems and occurs when an accidental electrical short circuit occurs between ground and one or more normally designated current-carrying conductors. These shorts may occur due to damage to wire insulation, mishandling of cables, and water infiltration, for example. If not properly protected, ground faults in PV systems and their associated PV arrays may result in large fault currents that may in turn increase the risk of fire hazards, reduce power production, and jeopardize the personal safety of maintenance personnel.

PV systems and grid-tied storage battery systems incorporate a ground fault detector/interrupter (GFDI) that detects ground faults, interrupts the fault current by breaking a fuse within the system, and communicates that a fault has occurred within the system. Upon detection of the fault the inverter shuts down not only the PV array or input channel within which the ground fault occurred but the entire system. The system shutdown therefore results in a substantial loss of energy production not only from a PV array/channel within which the fault occurred, but from all of the remaining healthy PV arrays/channels within the system. Additionally, electrical storms and lighting strikes generate conditions that resemble a ground fault within the system. The GFDI detects these conditions as a ground fault and unnecessarily shuts down the inverter, resulting in a significant drop of power production.

It would therefore be desirable to provide a DC-to-AC power conversion system and method for fault detection therein that identifies ground faults reliably and that is capable of distinguishing real faults from false detections. It would further be desirable for such a system to identify a fault location within the power system and continue to generate power while the identified ground fault is being addressed. Additionally, it would be desirable to replace the fuses typically used in PV systems and grid-tied storage battery systems with an electronically-controllable switching device that reduces maintenance costs and service time for the system.

### BRIEF DESCRIPTION OF THE INVENTION

Embodiments of the present invention provide systems and methods for detecting ground faults within DC-to-AC power conversion systems and selectively isolating portions of the systems based on the detected location of the ground fault.

In accordance with one aspect of the invention, a direct current (DC)-to-alternating current (AC) power conversion system includes a plurality of DC power source assemblies, each DC power source assembly comprising a plurality of DC power sources and a combiner coupled to the DC output from the plurality of DC power source assemblies. The combiner includes a plurality of positive conductors and a plurality of negative conductors. A power inverter is coupled to a DC output of the combiner and configured to invert the DC output to an alternating current (AC) output and a ground conductor electrically connected to a ground connection of the plurality of DC power sources. A ground current sensor is provided on the ground conductor. The DC-to-AC power conversion system also includes a controller programmed to identify a potential ground fault using current data received from the ground current sensor, identify a faulty DC power source assembly using current data received from a current sensor provided on at least one of the plurality of positive conductors and the plurality of negative conductors, and open a DC breaker switch on one of the plurality of positive conductors and a DC breaker switch on one of the plurality of negative conductors to disconnect the faulty DC power source assembly from the power inverter.

In accordance with another aspect of the invention, a method of isolating a ground fault within a DC-to-AC power conversion system that includes a plurality of DC power source assemblies coupled to a power inverter through a combiner is disclosed. The method includes sampling current on a plurality of conductors of the combiner and a ground conductor coupled to the plurality of DC power source assemblies and identifying a potential ground fault within the DC-to-AC power conversion system from the sampled current. The method also includes identifying a faulty DC power source assembly from the sampled current corresponding to at least one of a positive conductor and a negative conductor of the combiner and electronically activating a pair of DC breakers to disconnect the faulty DC power source assembly from the power inverter.

In accordance with yet another aspect of the invention, a photovoltaic (PV) power system includes a plurality of PV arrays each configured to generate a direct current (DC) output from received solar irradiation and a power inverter electronically coupled to the plurality of PV arrays to receive the DC output therefrom and invert the DC output to an AC output. A combiner couples the DC output from the plurality of PV arrays to an input of the power inverter, the combiner including a plurality of positive conductors and a plurality of negative conductors, each having a DC breaker provided thereon. A ground conductor is coupled to the plurality of PV arrays and has a current sensor provided thereon. A controller is in operable connection with the DC breakers and is programmed to locate a ground fault corresponding to one of the plurality of PV arrays from sampled current data received from current sensors provided on a plurality of conductors within the PV power system and decouple the PV array having the ground fault from the power inverter by electronically activating a pair of DC breakers corresponding to the PV array having the ground fault.

Various other features and advantages of the present invention will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a schematic illustration of a photovoltaic (PV) system according to an embodiment of the invention.

FIG. 2 is a schematic illustration of a PV system according to another embodiment of the invention.

FIG. 3 is a schematic illustration of a DC-to-AC power conversion system according to an embodiment of the invention.

FIG. 4 is a flowchart illustrating a technique for detecting ground faults and controlling operation of the PV systems of FIGS. 1 and 2 or the DC-to-AC power conversion system of FIG. 3 upon detection of a fault, according to embodiments of the invention.

FIG. 5 is a graph illustrating exemplary current data sampled from the ground fault conductor and a pair of positive and negative conductors according to the technique set forth in FIG. 4.

FIG. 6 is a graph illustrating exemplary current data sampled from a pair of positive and negative conductors according to the technique set forth in FIG. 4.

FIG. 7 is a graph illustrating exemplary current data sampled from a pair of positive and negative conductors according to the technique set forth in FIG. 4.

FIG. 8 is a flowchart illustrating a technique for detecting ground faults and controlling operation of a DC-to-AC power conversion system upon detection of a fault, according to another embodiment of the invention.

FIG. 9 is a flowchart illustrating a technique for detecting ground faults and controlling operation of a DC-to-AC power conversion system upon detection of a fault, according to yet another embodiment of the invention.

### DETAILED DESCRIPTION OF THE PREFERRED EMBODIMENTS

The embodiments of the invention set forth herein relate to systems and methods for detecting ground faults within a DC-to-AC power conversion system, such as a PV system containing one or more PV arrays or a backup power system containing grid-tied DC storage batteries. The DC-to-AC power conversion system includes current sensors that monitor current on the system ground conductor and on positive and/or negative DC conductors located within combiner or re-combiner structures. DC breakers are provided on the positive and negative DC conductors and are controlled to open upon detection of a ground fault, thereby isolating a faulty DC source from the inverter while permitting the inverter to continue to deliver with respect to DC inputs received from the remainder of DC input sources.

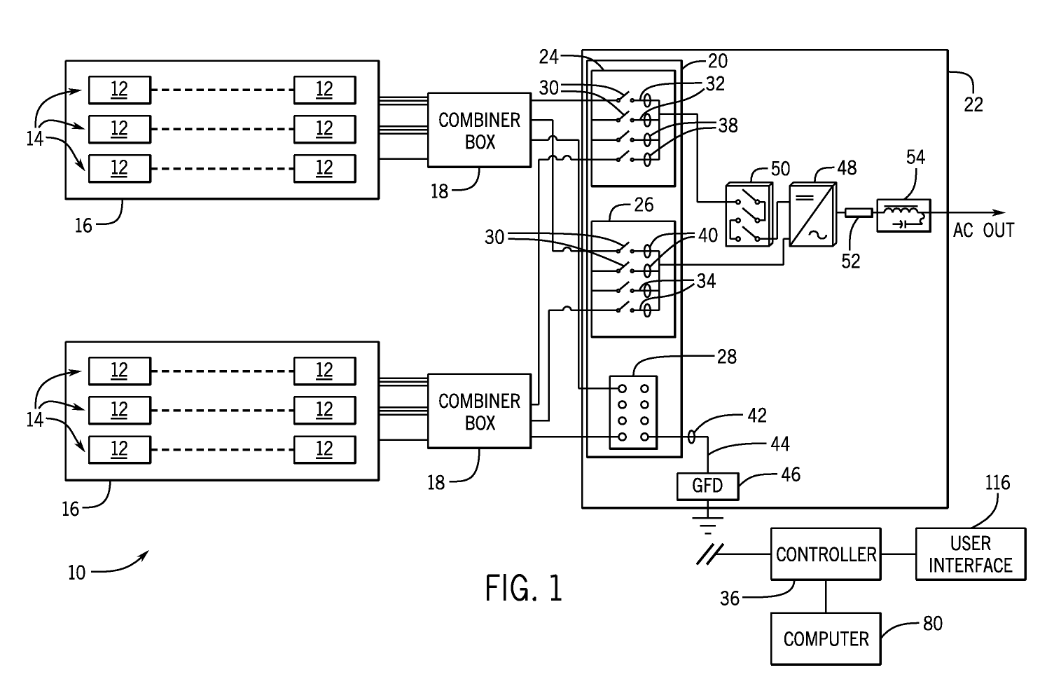

Referring to FIG. 1, a photovoltaic (PV) system 10 includes individual PV modules 12 or cells that are coupled in a series arrangement to form PV arrays 14 or strings. The PV arrays 14 are grouped together in PV array blocks 16. As known in the art, the number of PV modules 12 within each PV array 14, the number of PV arrays 14 within each PV array block 16, and the total number of PV array blocks 16 within PV system 10 may be selected based on design specifications to provide a desired DC electrical power when incident radiant energy from the sun impinges thereon. The DC power output from each PV array 14 is fed into a respective external combiner box 18. The output of each combiner box 18 is aggregated within a re-combiner 20 or master combiner that is located within an inverter housing 22 of the PV system 10.

Re-combiner 20 includes a positive bus bar 24, a negative bus bar 26, and a ground bus bar 28, with each bus bar 24, 26, 28 having connection terminals corresponding to the various input channels of the re-combiner 20. A DC breaker 30 is provided on each positive conductor 32 of the positive bus bar 24 and on each negative conductor 34 of the negative bus bar 26. The DC breakers 30 are electronically connected to a controller 36 that is programmed to selectively control the opening and closing of the electronic switching devices within the DC breakers 30. In one embodiment, DC breakers 30 are PVGard™ 600 Vdc or 1000 Vdc circuit breakers manufactured by Eaton Corporation. However, it is contemplated that DC breakers 30 may take the form of other types of electrically controllable circuit breakers in alternative embodiments.

As shown in FIG. 1, current sensors 38, 40, or shunts are provided on each positive conductor 32 and negative conductor 34, respectively. A ground current sensor 42 or shunt is provided on the ground fault detector indicator (GFDI) conductor 44, which couples the ground bus bar 28 to a ground fault detection (GFD) device 46. Current sensors 38, 40, 42 are galvanically isolated DC current monitoring devices, such as, for example, Hall effect sensors, that monitor current through the respective positive conductors 32, negative conductors 34, and GFDI conductor 44. According to various embodiments, current sensors 38, 40, 42 may be wired or wireless sensors that transmit real-time current signals reflective of the real time current output of PV arrays 14 to controller 36. In one embodiment current sensors 38, 40 are provided within DC breakers 30. Alternatively, current sensors 38, 40 are provided as separate devices. Based the current signals received from current sensors 38, 40, 42, controller 36 monitors for a ground fault within the PV system 10, determines the location of the ground fault within the PV system 10, and transmits switching signals to select DC breakers 30 to isolate a fault portion of the PV system 10 from the input of the inverter 48, as described in detail below.

Also provided within inverter housing 22 is a DC disconnect switch 50 that is coupled to the positive bus bar 24. DC disconnect switch 50 connects the positive bus bar 24 to a DC-to-AC power inverter 48 can be opened at the time of service to disconnect the DC output of PV arrays 14 from the inverter 48. Controller 36 functions to control switching of the plurality of switches within the inverter 48 causing the inverter 48 to convert the DC voltage output from the positive and negative bus bars 24, 26 to a fixed frequency AC output. While not shown in FIG. 1, one skilled in the art will recognize that the plurality of switches within inverter 48 may be in the form of any of a number of various switching elements or devices, including a relay, an IGBT, an SCR, a circuit breaker, sub-arrays of small contactors, or other suitable switching devices. The AC output is supplied to a transformer or power grid (not shown) after passing through a fuse 52 and filter 54 that are housed within inverter housing 22. While only one inverter 48 is provided within PV system 10, one skilled in the art will understand that the concepts disclosed herein may be extended to PV systems that include multiple inverters.

In the embodiment illustrated in FIG. 1 and described below, a common controller 36 controls operation of switching elements within inverter 48, receives output signals from current sensors 38, 40, 42, and controls operation of DC breakers 30. According to alternative embodiments, separate controllers may be provided to control operation of the switching elements within inverter 48 and operation of DC breakers 30.

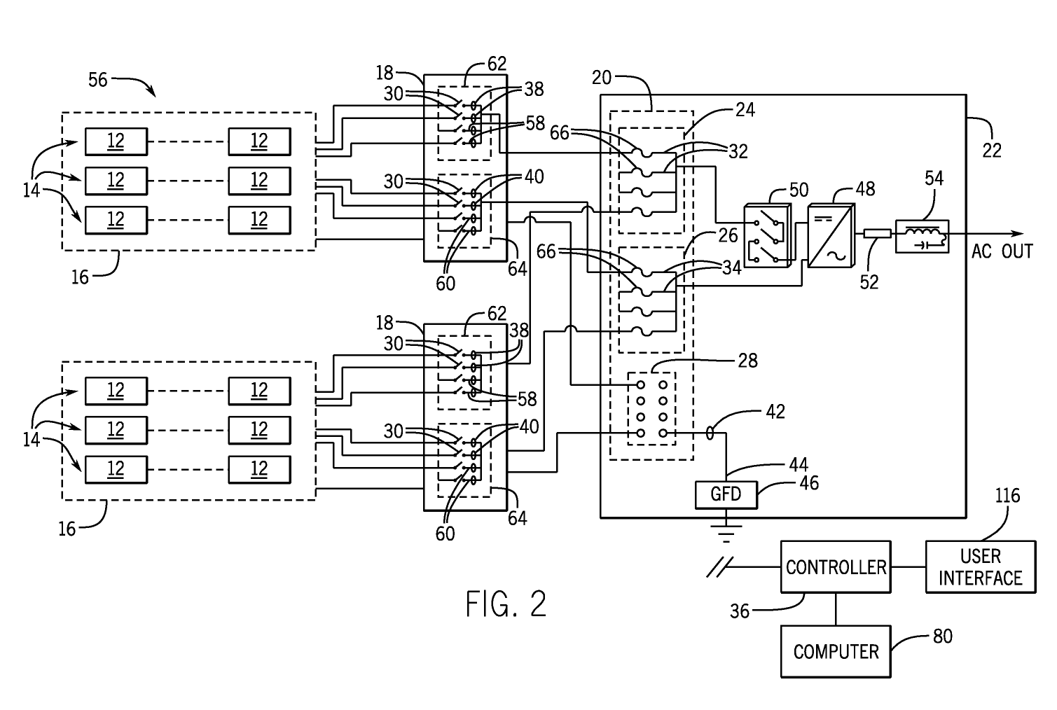

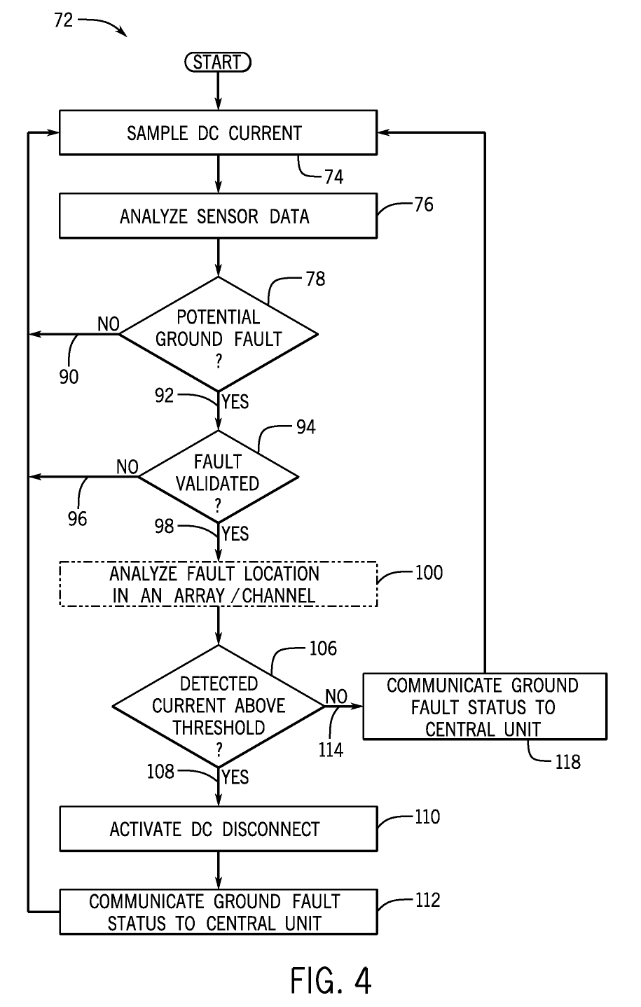

FIG. 2 illustrates a PV system 56 in accordance with an alternative embodiment of the invention. PV system 56 includes components similar to components shown in PV system 10 of FIG. 1, and thus numbers used to indicate components in FIG. 1 will also be used to indicate similar components in FIG. 2. As shown, PV system 56 includes PV modules 12 combined in series to form PV arrays 14. The PV arrays 14 are grouped together into PV array blocks 16, with the DC power output of the PV arrays 14 for a given PV array block 16 being combined together within a respective combiner box 18. PV system 56 differs from PV system 10 of FIG. 1 in that DC breaker switches 30 and current sensors 38, 40 are provided on the respective positive conductors 58 and negative conductors 60 of the positive bus bar 62 and negative bus bar 64 in each combiner box 18, rather than within the re-combiner 20. Fuses 66 are provided on each of positive conductor 32 and negative conductor 34 of the re-combiner 20. Controller 36 is programmed to selectively operate DC breakers 30 in a similar manner as referenced above with respect to FIG. 1 and as described in additional detail below with respect to FIG. 4.

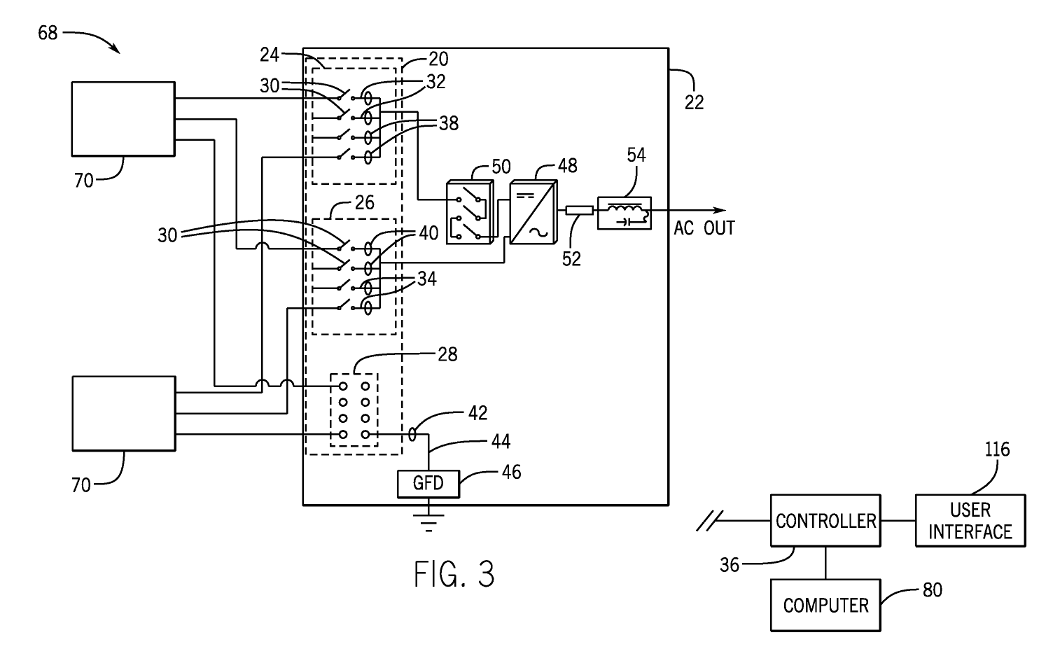

FIG. 3 illustrates an DC-to-AC power conversion system 68 in accordance with alternative embodiments of the invention. DC/AC power conversion system 68 includes similar components as PV system 10 of FIG. 1, and thus part numbers used to indicate components in FIG. 1 will also be used to indicate similar components in FIG. 3. As shown, DC/AC power conversion system 68 is configured in a similar manner as described with respect to FIG. 1, with DC breaker switches 30 and current sensors 38, 40 provided on the respective positive conductors 32 and negative conductors 34 of re-combiner 20. DC/AC power conversion system 68 also includes a plurality of DC energy sources 70, the output of which is fed into re-combiner 20. In one embodiment, DC energy sources 70 are PV arrays constructed of multiple PV modules arranged in series, similar to PV arrays 14 of FIG. 1. In an alternative embodiments, DC energy sources 70 are DC storage batteries, banks of DC storage batteries, or a combination of PV arrays and DC storage batteries that are configured to deliver auxiliary power to a power grid upon demand. In any of these embodiments, controller 36 is programmed to monitor for a ground fault within DC/AC power conversion system 68 and selectively open DC breakers 30 in accordance with the ground fault detection technique described with respect to FIG. 4.

Referring now to FIG. 4, and with continued reference to FIGS. 1-3 as appropriate, a technique 72 for sensing a ground fault, locating the ground fault on a specific PV array 14, combiner box 18, or input channel of a re-combiner 20, and isolating the ground fault via control of appropriate DC breakers 30 is set forth according to embodiments of the invention. Technique 72 is performed by a controller (e.g., controller 36) or a similar device that is programmed with a ground fault detection algorithm that detects sudden and gradual ground faults as described in more detail below.

Technique 72 samples DC current data received from current sensors 38, 40, 42 at block 74. According to various embodiments, the DC current sampling is carried out continuously or at predefined intervals during operation of systems 10, 56, and 68. The DC current data received from ground current sensor 42 is analyzed at block 76 for a potential ground fault. The ground fault detection algorithm implemented by technique 72 is programmed to detect two types of ground faults: sudden ground faults and gradual ground faults. Sudden ground faults occur due to a sudden electrical short, which may be caused by animal damage to a conductor or a lightning strike, as non-limiting examples. Gradual ground faults occur as a result of deterioration of components within systems 10, 56, 68 and worsen over time. As described in more detail below, the ground fault detection algorithm carried out by technique 72 detects gradual ground faults by monitoring a detected current within the ground conductor 44 as compared to a threshold current value. Technique 72 detects sudden ground faults two ways: by monitoring a threshold current value and by recognizing a pattern within the sensed DC current data.

At block 78 technique 72 compares the sampled DC current data from ground current sensor 42 to threshold current values stored within a lookup table. The results of this comparison are used to determine whether a gradual or sudden ground fault has potentially occurred. In one embodiment, threshold current values for the comparison are defined from UL standards based on the DC power rating of the inverter 48. An exemplary lookup table of threshold current values defined by UL standards is provided in Table 1.

TABLE 1

| Inverter Power Rating (kW) | Ground Fault Threshold (Amperes) |
|---|---|
| 0-25 | 1 |
| 25-50 | 2 |
| 50-100 | 3 |
| 100-250 | 4 |
| >250 | 5 |

It is contemplated that the threshold values may be determined by other means than UL standards based on design specifications for a particular application, according to alternative embodiments of the invention.

At block 78 technique 72 also detects a possible sudden ground fault by analyzing the sampled DC current data for patterns indicative of sudden ground faults. This pattern recognition is carried out by analyzing the sensed DC current data received from current sensor 42 over a predefined period of time, such as 5 milliseconds as a non-limiting example. The sensed DC current data is filtered such that it is immune to noise and includes data captured during the relevant frequency window for pattern detection. The filtered DC current data is compared to predefined current patterns indicative of ground faults.

Current patterns indicative of ground faults are dependent upon the operating characteristics and specifications of PV modules or storage batteries, the number of PV modules or storage batteries connected in series, the construction and length of the various conductors, and the configuration of the combiners and any re-combiners included within the system. According to various embodiments, current patterns indicative of ground faults may be defined based on the settling time of the sensed current data and/or an integrated pattern within the sensed current data, as non-limiting examples. In one embodiment, controller 36 or an internal memory module thereof is preprogrammed with a number of predefined current patterns indicative of ground faults for various types of PV modules and/or storage batteries, conductor characteristics, and combiner configurations. When integrated within a particular PV system or DC/AC power conversion system, controller 36 is configured to access the predefined current patterns appropriate for the configuration of the particular system. In another embodiment, controller 36 is programmed to operate in a learning mode that identifies current patterns indicative of ground faults during operation of the PV system or DC/AC power conversion system. When ground faults are identified, controller 36 operates an algorithm that analyzes patterns within the sensed current data received from current sensor 42 prior to identification of the ground faults. These patterns are saved within a memory module of the controller 36 or a computer 80 or external storage device coupled to the controller 36. Controller 36 is programmed to access these stored patterns to identify potential ground faults during later operation of the PV system or DC/AC power conversion system.

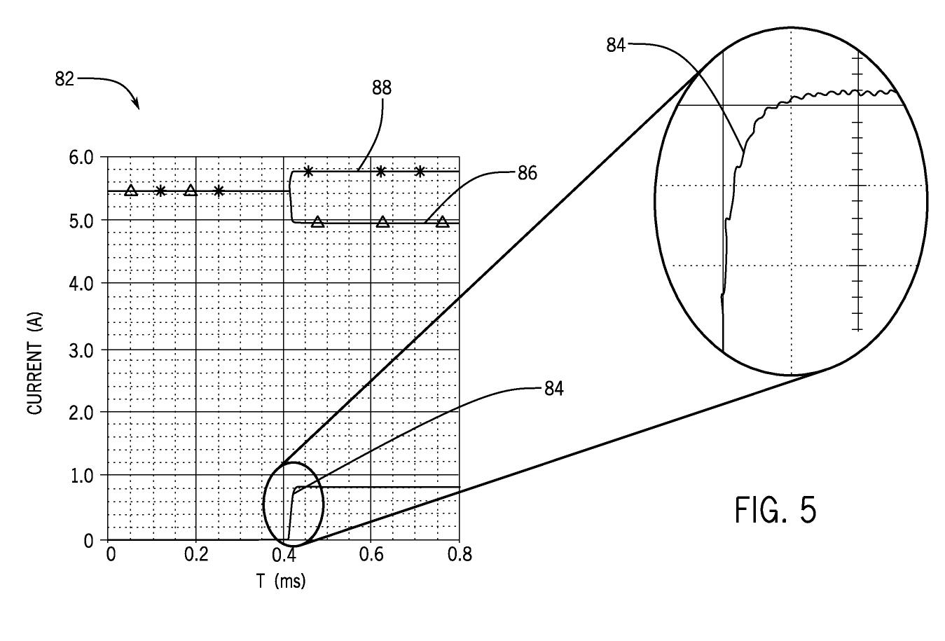

A graph 82 containing exemplary sampled current data indicative of a potential ground fault is illustrated in FIG. 5. Graph 82 includes sampled current data 84 from ground current sensor 42 in combination with sampled current data 86, 88 from a pair of positive and negative current sensors 38, 40 corresponding a particular PV array block 16 (FIG. 1), a combiner box 18 (FIG. 2), or a DC energy source 70 (FIG. 3). One skilled in the art will recognize that the numerical values illustrated in FIG. 5 are provided for explanatory purposes only and are non-limiting. As shown, the ground current 84 exceeds zero (0) at 0.4 ms, indicating a potential ground fault. Following the potential ground fault, technique 72 samples the ground current data 84 and compares the sampled value to the threshold values stored in the look-up table as explained above. A sudden or gradual ground fault may be identified based on the comparison. Technique 72 also analyzes the ground current data 84 acquired during a predetermined time window for patterns indicative of sudden ground faults. In the illustrated example, technique 72 performs the above-described pattern recognition subroutine on the ground current data 84 acquired between t=0.4 ms and t=0.42 ms.

If a ground fault pattern is not detected within the sampled DC current data or if the sampled DC current data from current sensor 42 is below the threshold 90, technique 72 returns to block 74 and continues to sample the DC current data. If a ground fault pattern is detected within the sampled DC current data received from current sensor 42 or if the sampled DC current data from current sensor 42 exceeds the threshold, a potential fault is identified 92 and technique 72 proceeds to block 94 to validate the ground fault.

At block 94, technique 72 uses the sampled current data from the current sensors 38 on the positive bus bar 24 and the current sensors 40 on the negative bus bar 26 to validate a potential ground fault. Any possible current leakage or ground faults in the PV system 10 are assessed by comparing the sampled current data from current sensors 38 and current sensors 40 corresponding to a given combiner box 18 or PV array 14, depending on the system configuration. For a PV system 10 configured as shown in FIG. 1 where current sensors 38, 40 are located within a re-combiner 20 and sense current data output from multiple combiner boxes 18, technique 72 compares positive current data to negative current data for each combiner box 18 (i.e., each input channel of re-combiner 20). Thus the positive current data sensed by a current sensor 38 for a given input channel of re-combiner 20 is compared to the negative current data sensed by a current sensor 40 for the given input channel according to:

ΔIGF≈Δ└I₍₊₎−I₍₋₎┘ (Eqn. 1)

where IGF is a detected ground fault current, I₍₊₎ is the sensed current from a positive current sensor 38, and I₍₋₎ is the sensed current from a corresponding negative current sensor 40. If no discrepancy exists between the sensed currents on a given pair of positive and negative conductors (i.e., ΔIGF=0), the potential ground fault is not validated 96 and technique 72 continues to sample DC current data at block 74. If a discrepancy does exist between the sensed currents on a given pair of positive and negative conductors (i.e., ΔIGF>0), a ground fault is validated within the PV system 98. Technique 72 operates to validate a ground fault in a similar manner for the DC/AC power conversion system 68 of FIG. 2 and the PV system 56 of FIG. 3 by comparing sensed current data from current sensors 38 to sensed current data from current sensors 40.

When a ground fault is validated 98, technique 72 may optionally proceed to block 100 (shown in phantom) to determine the approximate location of the ground fault using sensed current data from positive and negative current sensors 38, 40. Since the current in a positive conductor is equal to the current in a corresponding negative conductor during normal operation, deviations in the sensed current within a corresponding pair of positive and negative conductors can be used to identify ground fault location. In embodiments configured similar to PV system 10 of FIG. 1, where positive and negative current sensors 38, 40 are located within a re-combiner 20 coupled to multiple combiner boxes 18, technique 72 is configured to identify a particular input channel of a combiner box 18 corresponding to the fault. In this manner, technique 72 may be used to isolate the PV array block 16 containing the ground fault. In embodiments configured similar to PV system 56 of FIG. 2 or DC/AC power conversion system 68 of FIG. 3, technique 72 may be used to identify the approximate location of a ground fault within a string of series connected PV modules 12 of a particular PV array 14 or within a series connection of a number of DC storage batteries. In either case, the capability of the ground fault detection algorithm to determine the location (or approximate location) of the ground fault within the system 10, 56, 68 can be leveraged for diagnostic and repair purposes.

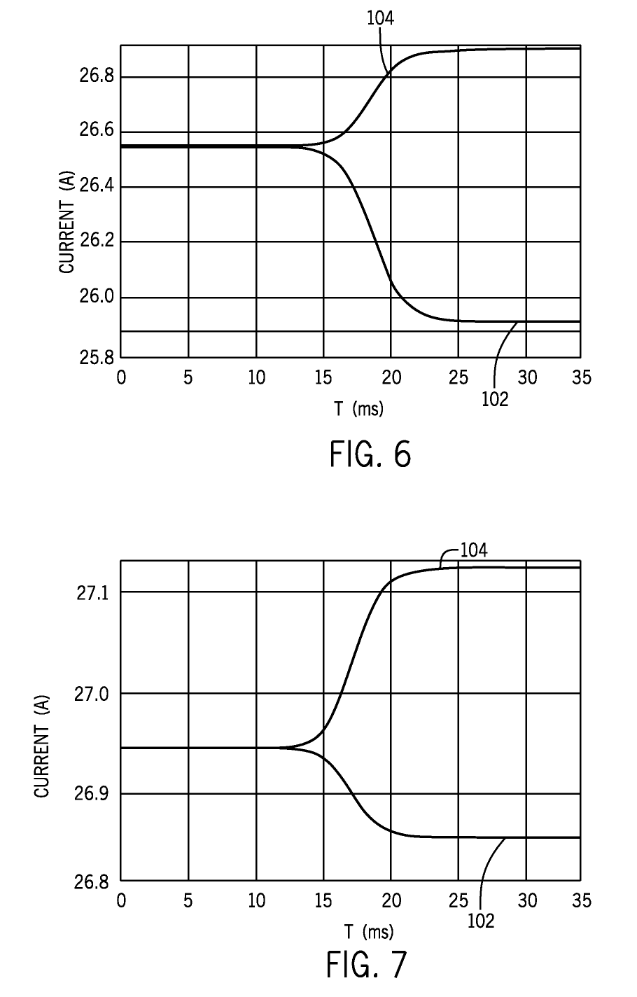

The approximate ground fault location is analyzed using the ratio of the change in current sensed by a respective pair of positive and negative current sensors 38, 40. The graphs provided in FIGS. 6 and 7 illustrate exemplary current data corresponding to a positive and negative conductor pair within any of systems 10, 56, and 68. One skilled in the art will understand that the numerical values illustrated in FIGS. 6 and 7 are non-limiting and are provided for explanatory purposes only and that actual current values detected by current sensors 38, 40 will vary depending on system configurations. In the examples illustrated in FIG. 6 and FIG. 7, during normal operation a respective pair of positive and negative current sensors 38, 40 detects respective currents of approximately 26.47 A and 26.95 A. A ground fault occurs at approximately t=13 ms, causing the current sensed by sensors 38, 40 to deviate from the current detected during normal operation. When the current data is sampled at t=30 ms, ΔIGF deviates from zero and indicates a ground fault. Technique 72 calculates a ratio of the change in sensed currents I₍₋₎ and I₍₊₎ from respective negative current sensor 40 and positive current sensor 38 the according to:

$$CurrentRatio = \frac{Δ {I}_{( - )}}{{Δ I}_{( + )}} \qquad ( Eqn . 2 )$$

In the example shown in FIG. 6, the ratio of the change in positive current 102 to the change in negative current 104 over a predefined time period such as, for example 30 ms, is greater than one (1) and thus indicates that the ground fault is located closer to the positive conductor than the negative conductor. In the example shown in FIG. 7, the ratio of the change in negative current 104 to the change in positive current 102 over a predefined time period such as, for example 30 ms, is less than one (1), thereby indicating that the ground fault is located closer to the negative conductor than the positive conductor. In the PV system 56 of FIG. 2, for example, the sampled currents of FIG. 6 indicate a ground fault located in a PV module 12 coupled proximate the positive conductor of a given input channel of combiner box 18 whereas the sampled currents of FIG. 7 indicate a ground fault located in a PV module 12 coupled proximate the negative conductor of the given input channel.

At block 106 technique 72 compares the detected ground fault current, IGF, to a series of predefined threshold current values that are stored within a lookup table and that are divided into a number of zones that are used for prognostics. In one embodiment, one or more of the threshold current values are defined from UL standards that are based on the DC power rating of the inverter 48, similar to Table 1 provided above. In alternative embodiments, threshold values may be determined by other safety standards, design specifications, or other means. As shown in exemplary Table 2 below, a detected ground fault current IGF below a first threshold value (1 A in the illustrated example) falls within Warning Zone 1, a detected ground fault current IGF below a second threshold value (≦3 A in the illustrated example) falls within Warning Zone 2, a detected ground fault current IGF below a third threshold value (5 A in the illustrated example) falls within Warning Zone 3, and a detected ground fault current IGF above a fourth threshold value (≧5 A in the illustrated example) falls within Warning Zone 4. The number of warning zones, current thresholds for each warning zone, and action associated with each warning zone may be selected for a particular application or system arrangement and are not to be considered limited by the exemplary values provided in Table 2.

TABLE 2

| | Ground Fault Current | |
|---|---|---|
| Warning Zone | Threshold (Amperes) | Action |
| 1 | IFG ≦1 | No Warning |
| 2 | 1 < IGF ≦ 3 | Issue Potential Ground Fault |
| | | Warning |
| 3 | 3 < IGF < 5 | Issue Critical Warning |
| 4 | IGF≧5 | Disconnect Faulty Array |

Technique 72 carries out an action corresponding to the particular warning zone determined by the detected ground fault current IFG. Where the detected ground fault current IGF falls within the highest warning zone and exceeds the threshold disconnect current 108, controller 36 activates the DC breakers 30 on the positive and negative conductors on the channel corresponding to the faulty array at block 110 thereby disconnecting the output of the faulty array from the inverter assembly 22. At block 112, the status of the detected ground fault is communicated to a central unit, computer 80, or operator interface 116.

If the detected ground fault current IGF is below the disconnect current threshold 114, the controller 36 communicates a ground fault status to a central unit, computer 80, or operator interface 116 at block 118. An audible and/or visual indicator may be displayed in connection with the communicated ground vault status at block 118. For example, where the detected ground fault current IFG falls within Warning Zone 2 a yellow indicator light indicating a potential ground fault may be displayed on operator interface 116 and where the detected ground fault current IFG falls within Warning Zone 3 a red indicator light indicating a potential ground fault may be displayed on operator interface 116. After communicating the ground fault status at block 112 or block 118, technique 72 continues to sample current data at block 74.

In one embodiment, technique 72 is configured to account for situations where a detected ground fault “self-corrects” over time, thereby eliminating unnecessary service calls and reducing repair costs. Where a Zone 4 ground fault has occurred in a particular array or input channel, for example, technique 72 will cause controller 36 to close the DC breaker 30 corresponding to the faulty array or channel for a short duration (e.g., several milliseconds) during which current data from the ground current sensor 42 and corresponding positive and negative current sensors 38, 40 is monitored and analyzed as described with respect to blocks 74-106. If a ground fault within the particular array or input channel is confirmed from the sensed current data, the previously identified ground fault is confirmed and controller 36 reopens the DC breaker 30. If a ground fault is not detected within the sensed current data, technique 72 determines that the previously detected ground fault has self-corrected and the corresponding DC breaker 30 is closed, thereby permitting power conversion from the previously disconnected array or input channel. It is contemplated that checks for ground fault self-correction may be carried out a predefined, regular intervals, such as every 30 minutes as one non-limiting example.

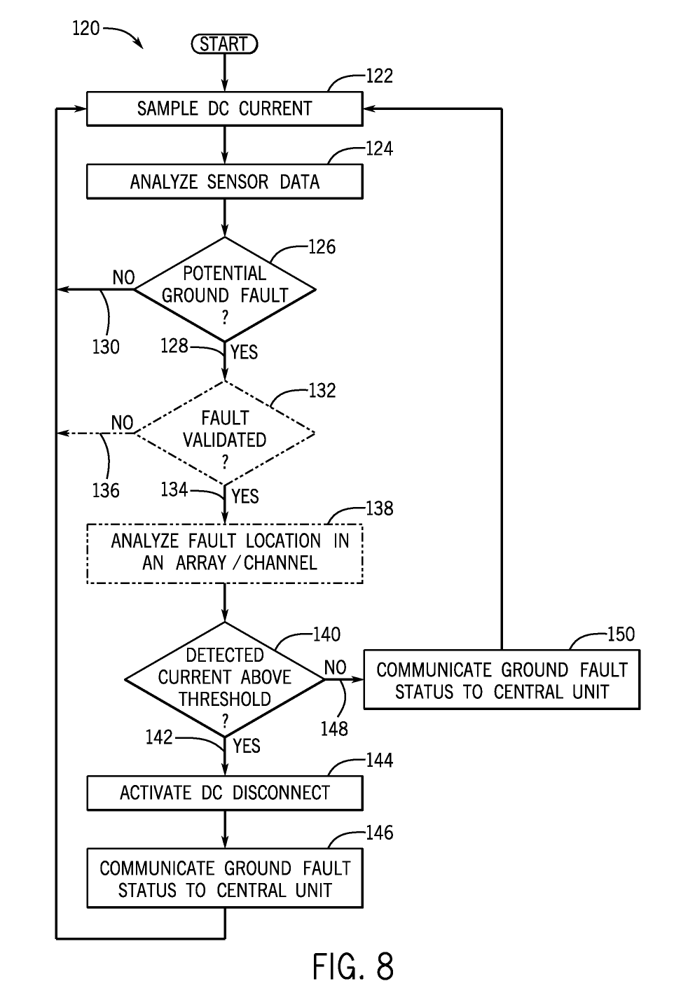

An alternative technique 120 for sensing and isolating a ground fault is illustrated in FIG. 8 in accordance with another embodiment of the invention. Similar to technique 72 (FIG. 4), technique 120 is usable with systems 10, 56, and 68 of FIGS. 1-3 and is performed by a controller (e.g., controller 36) or similar device, which is programmed with an algorithm that operates to detect and isolate ground faults in accordance with the steps set forth below.

Technique 120 begins by sampling DC current data from positive current sensors 38 and negative current sensors 40 at block 122 during operation of system 10, 56, or 68. Optionally, current data from ground current sensor 42 is also sampled at block 122. Sampling may be carried out continuously or at predefined intervals, according to alternative embodiments. After sampling, the DC current data is filtered to remove noise and to include data corresponding to a desired frequency window for pattern detection. The sampled and filtered DC current data is analyzed at block 124 for a potential ground fault. As part of the current analysis, the positive current data sensed by a positive current sensors 38 are compared to the negative current data sensed by negative current sensors 40, according to Eqn. 1. Technique 120 determines whether a potential ground fault exists at block 126 based on the comparison. Technique 120 detects a potential fault 128 where a discrepancy is found between the sensed positive and negative currents (i.e., ΔIGF>0) and does not identify a potential fault 130 the sensed current on a given pair of positive and negative conductors is equal (i.e., ΔIGF=0).

When a potential ground fault is detected from the comparison of positive and negative current sensor data, technique 120 optionally validates the potential ground fault at block 132 (shown in phantom) using current data sampled using ground current sensor 42. In addition to simply confirming the presence of a ground fault within system 10, 56, or 68, this optional validation step may also be used to determine whether the ground fault is a sudden fault or a gradual fault. The sampled and filtered ground current data is compared to threshold current values stored within a lookup table and to predefined current patterns indicative of ground faults in a similar manner as described with respect to block 78 of technique 72 (FIG. 4). A ground fault is validated 134 when the sampled ground current exceeds a threshold indicative of a fault. Where the sampled ground current does not exceed a fault threshold, the potential ground fault is not validated 136 and technique 120 returns to block 122 and continues to sample current data.

After identifying a ground fault using either the positive and negative current data or a combination of the positive, negative, and ground current data, technique 120 may use the positive and negative current data at optional block 138 (shown in phantom) to analyze the location of the fault location in a particular PV array or channel of the system 10, 56, or 68. The fault location analysis is carried out in a similar manner as described with respect to block 100 of FIG. 4.

Technique 120 determines what type of action to take based on the detected ground fault at block 140. The action is determined based on a comparison of the magnitude of the current ratio calculated using Eqn. 2 and predefined threshold current values stored within a lookup table in a similar manner as described with respect to block 106 of technique 72. Where the current ratio exceeds the threshold value for a disconnect 142, technique 120 activates the DC breakers 30 on the positive and negative conductors of the channel corresponding to the faulty array at block 144 and issues an appropriate communication for the ground fault status at block 146. Where the current ratio is below the threshold value for a disconnect 148, technique 120 communicates the ground fault status corresponding to the particular warning zone for the calculated current ratio at block 150.

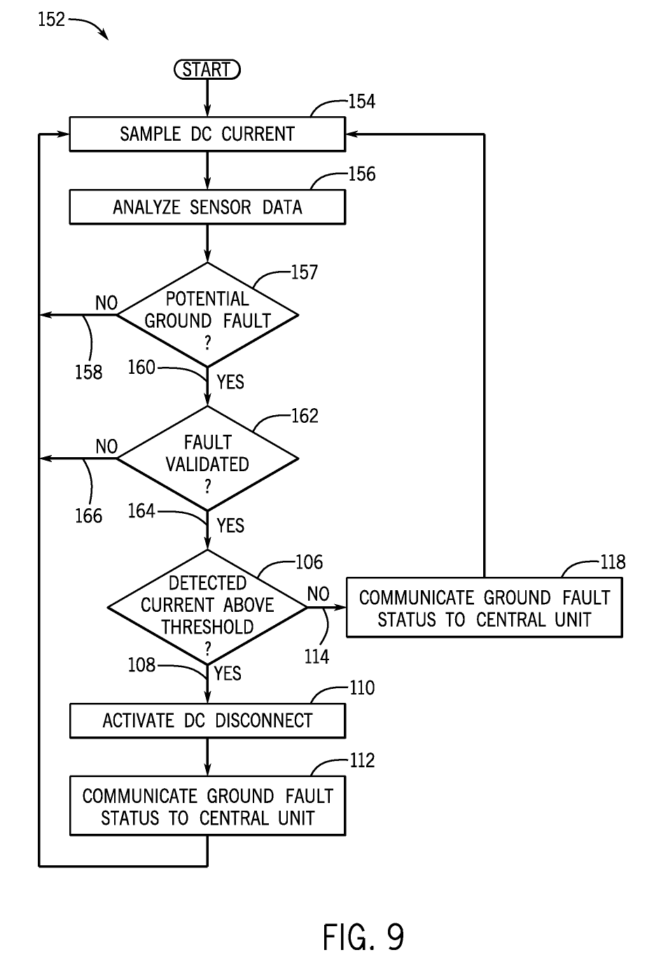

An alternative ground fault detection and isolation technique 152 is illustrated in FIG. 9. Technique 152 is operable in DC/AC power conversion systems that include a ground current sensor similar to sensor 42 of FIGS. 1-3 in combination with current sensors on either the positive conductors or negative conductors. In other words, technique 152 is operable in a system configured in a similar manner as system 10, 56, or 68 but that omits either positive current sensors 38 or negative current sensors 40. Omission of either positive current sensors 38 or negative current sensors 40 results in a simplified and lower cost system. Below, technique 152 is described with respect to a system that includes positive current sensors 38 and omits negative current sensors 40. However, one skilled in the art will recognize that technique 152 may easily be extended to a system having only negative current sensors 40 in combination with a ground current sensor 42. Technique 152 is carried out by a controller, such as controller 36, which is programmed with an algorithm that detects and isolates ground faults in the manner described below.

Technique 152 begins by sampling current data from positive current sensors 38 and ground current sensor 42 at block 154. The sampled current data is filtered in a similar manner as described above with respect to block 76 of FIG. 4. The filtered ground current data is analyzed at block 156 to detect the presence of a potential ground fault based on the magnitude of the sampled ground current and patterns detected within the sampled ground current. At block 157 technique 152 uses the filtered ground current data to determine whether a potential sudden or gradual ground fault exists by comparing the ground current data to threshold values and using pattern recognition, in a similar manner as described with respect to block 78 of FIG. 4. If a potential ground fault is not detected 158, technique 152 returns to block 154 and continues to sample current data. If a potential ground fault is detected 160, the potential fault is validated at block 162 using the sampled current data from positive current sensors 38.

The ground fault validation is carried out by comparing sampled current data from the positive current sensors 38 to the sampled current data from ground current sensor 42. Specifically, technique 152 analyzes the positive current data acquired during the same time period in which the ground current data indicative of the potential ground fault was acquired. Where the change in positive current sampled by a particular positive current sensor 38 is validated by correlating sampled current data from ground current sensor 42, technique 152 validates a ground fault on the appropriate array or channel 164. Otherwise, the potential ground fault is not validated 166 and technique 152 returns to block 154 and continues to sample current data. After validating a ground fault, technique 152 uses the sampled ground current data to determine ground fault status, activate DC disconnects if appropriate, and communicate ground fault status as described with respect to blocks 106, 110, 112, and 118 of technique 72 (FIG. 4).

Beneficially, the combination of DC breakers 30 and current sensors 38, 40 within the systems disclosed in FIGS. 1-3 and the associated techniques 72, 120, 152 of FIGS. 4, 8, and 9 provide the ability to distinguish between real ground faults and “false” ground faults that may be detected from power surges that occur during electrical storms and lightning strikes. The systems and technique disclose herein also provides the ability to isolate the location of a ground fault within an individual array or input channel without interrupting regular operation of the inverter with respect to the remainder of the arrays or input channels. Unlike prior art systems that initiate a complete shutdown of the inverter upon detection of a ground fault, the inverter assembly 22 of the present invention continues to operate as normal with the exception of being disconnected from the output of the faulty array or input channel. Such operation results in a significant savings of energy production as compared to prior art systems following a detected ground fault. Techniques 72, 120, 152 also increase service fleet availability by permitting added flexibility in the scheduling of repairs. Rather that requiring service personal to be sent every time a ground fault occurs, the benefits of techniques 72, 120, 152 can be leveraged to repair damage causing multiple ground faults during one service call. Diagnostics from the operation of techniques 72, 120, 152 can also be used to minimize the duration of the service calls, by permitting the repair personal to isolate the location of the ground fault within a system, a benefit that is particularly advantageous in large PV systems constructed of hundreds or thousands of PV modules.

A technical contribution for the disclosed method and apparatus is that it provides for a controller implemented technique for detecting a ground fault within a DC-to-AC power conversion system, such as a PV system, and isolating the detected ground fault while permitting the remainder of the system to operate normally.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not listed may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

Therefore, according to one embodiment of the present invention, a direct current (DC)-to-alternating current (AC) power conversion system includes a plurality of DC power source assemblies, each DC power source assembly comprising a plurality of DC power sources and a combiner coupled to the DC output from the plurality of DC power source assemblies. The combiner includes a plurality of positive conductors and a plurality of negative conductors. A power inverter is coupled to a DC output of the combiner and configured to invert the DC output to an alternating current (AC) output and a ground conductor electrically connected to a ground connection of the plurality of DC power sources. A ground current sensor is provided on the ground conductor. The DC-to-AC power conversion system also includes a controller programmed to identify a potential ground fault using current data received from the ground current sensor, identify a faulty DC power source assembly using current data received from a current sensor provided on at least one of the plurality of positive conductors and the plurality of negative conductors, and open a DC breaker switch on one of the plurality of positive conductors and a DC breaker switch on one of the plurality of negative conductors to disconnect the faulty DC power source assembly from the power inverter.

According to another embodiment of present invention, a method of isolating a ground fault within a DC-to-AC power conversion system that includes a plurality of DC power source assemblies coupled to a power inverter through a combiner is disclosed. The method includes sampling current on a plurality of conductors of the combiner and a ground conductor coupled to the plurality of DC power source assemblies and identifying a potential ground fault within the DC-to-AC power conversion system from the sampled current. The method also includes identifying a faulty DC power source assembly from the sampled current corresponding to at least one of a positive conductor and a negative conductor of the combiner and electronically activating a pair of DC breakers to disconnect the faulty DC power source assembly from the power inverter.

According to yet another embodiment of the present invention, a photovoltaic (PV) power system includes a plurality of PV arrays each configured to generate a direct current (DC) output from received solar irradiation and a power inverter electronically coupled to the plurality of PV arrays to receive the DC output therefrom and invert the DC output to an AC output. A combiner couples the DC output from the plurality of PV arrays to an input of the power inverter, the combiner including a plurality of positive conductors and a plurality of negative conductors, each having a DC breaker provided thereon. A ground conductor is coupled to the plurality of PV arrays and has a current sensor provided thereon. A controller is in operable connection with the DC breakers and is programmed to locate a ground fault corresponding to one of the plurality of PV arrays from sampled current data received from current sensors provided on a plurality of conductors within the PV power system and decouple the PV array having the ground fault from the power inverter by electronically activating a pair of DC breakers corresponding to the PV array having the ground fault.

The present invention has been described in terms of the preferred embodiments, and it is recognized that equivalents, alternatives, and modifications, aside from those expressly stated, are possible and within the scope of the appending claims.

What is claimed is:

1. A direct current (DC)-to-alternating current (AC) power conversion system comprising:
a plurality of DC power source assemblies, each DC power source assembly comprising a plurality of DC power sources;
a combiner coupled to the DC output from the plurality of DC power source assemblies, the combiner comprising:
a plurality of positive conductors; and
a plurality of negative conductors;
a power inverter coupled to a DC output of the combiner and configured to invert the DC output to an alternating current (AC) output;
a ground conductor electrically connected to a ground connection of the plurality of DC power sources;
a ground current sensor provided on the ground conductor; and
a controller programmed to:
identify a potential ground fault using current data received from the ground current sensor;
identify a faulty DC power source assembly using current data received from a current sensor provided on at least one of the plurality of positive conductors and the plurality of negative conductors; and
open a DC breaker switch on one of the plurality of positive conductors and a DC breaker switch on one of the plurality of negative conductors to disconnect the faulty DC power source assembly from the power inverter.

2. The system of claim 1 wherein the plurality of DC power source assemblies comprise a plurality of PV arrays configured to generate a direct current (DC) output from received solar irradiation.

3. The system of claim 1 wherein the plurality of DC power source assemblies comprise a plurality of DC storage batteries.

4. The system of claim 1 wherein the controller is further programmed to:
identify the potential ground fault by comparing current data received from the ground current sensor to a first predefined threshold;
if the current data received from the ground current sensor exceeds the first predefined threshold, validate the potential ground fault by summing current data received from a positive current sensor and a negative current sensor corresponding to a common DC power source assembly; and
if the summation of the current data exceeds a second predefined threshold, opening the DC breaker switches corresponding to the common DC power source assembly.

5. The system of claim 1 wherein the controller is further programmed to identify the faulty DC power source assembly using current data received from current sensors provided on the plurality of positive conductors and the plurality of negative conductors.

6. The system of claim 1 wherein the controller is further programmed to:
detect a current pattern within current data received from the ground current sensor;
compare the detected current pattern to predefined current patterns indicative of ground faults; and
identify a sudden ground fault based on the comparison.

7. The system of claim 6 wherein the controller is further programmed to:
output at least one of an audible warning and a visual warning if the current data received from the ground current sensor exceeds a first threshold value; and
open a pair of DC breaker switches if the current data received from the ground current sensor exceeds a second threshold value;
wherein the second threshold value is greater than the first threshold value.

8. The system of claim 7 wherein after identifying the faulty DC power source the controller is further programmed to:
temporarily reclose the DC breaker switch on the positive conductor and the DC breaker switch on the negative conductor;
receive current data from the ground current sensor following the reclosure;
compare the received current data to a threshold; and
reopen the DC breaker switch on the positive conductor and the DC breaker switch on the negative conductor if the received current data exceeds the threshold.

9. A method of isolating a ground fault within a DC-to-AC power conversion system that includes a plurality of DC power source assemblies coupled to a power inverter through a combiner, the method comprising:
sampling current on a plurality of conductors of the combiner and a ground conductor coupled to the plurality of DC power source assemblies;
identifying a potential ground fault within the DC-to-AC power conversion system from the sampled current;
identifying a faulty DC power source assembly from the sampled current corresponding to at least one of a positive conductor and a negative conductor of the combiner; and
electronically activating a pair of DC breakers to disconnect the faulty DC power source assembly from the power inverter.

10. The method of claim 9 further comprising:
calculating a ratio of the measured current on a negative conductor and a positive conductor corresponding to the faulty DC power source assembly; and
determining a location of a ground fault within the faulty DC power source assembly based on the calculated ratio.

11. The method of claim 10 wherein determining the location of the ground fault comprises identifying a faulty PV module within a string of PV modules.

12. The method of claim 9 further comprising:
comparing the sampled current on the ground conductor to a predefined threshold; and
identifying the potential ground fault based on the comparison.

13. The method of claim 12 further comprising:
for each channel of the combiner, comparing the sampled current on a negative conductor to the sampled current on a corresponding positive conductor; and
validating the potential ground fault for a given channel of the combiner if the sampled current on the negative conductor differs from the sampled current on the corresponding positive conductor.

14. The method of claim 9 further comprising identifying a sudden ground fault based on a pattern detected in the sampled current on the ground conductor.

15. The method of claim 9 further comprising:
calculating a ground fault current, IGF, for a given channel of the combiner according to IGF=I₍₊₎−I₍₋₎, where I₍₊₎ is the sampled current on the positive conductor of the given channel and I₍₋₎ is the sampled current on the negative conductor of the given channel; and
electronically activating a pair of DC breakers for the given channel if the calculated ground fault current exceeds a predefined current threshold.

16. A photovoltaic (PV) power system comprising:
a plurality of PV arrays each configured to generate a direct current (DC) output from received solar irradiation;
a power inverter electronically coupled to the plurality of PV arrays to receive the DC output therefrom and invert the DC output to an AC output;
a combiner coupling the DC output from the plurality of PV arrays to an input of the power inverter, the combiner comprising a plurality of positive conductors and a plurality of negative conductors, each having a DC breaker provided thereon;
a ground conductor coupled to the plurality of PV arrays and having a current sensor provided thereon; and
a controller in operable connection with the DC breakers, the controller programmed to:
locate a ground fault corresponding to one of the plurality of PV arrays from sampled current data received from current sensors provided on a plurality of conductors within the PV power system; and
decouple the PV array having the ground fault from the power inverter by electronically activating a pair of DC breakers corresponding to the PV array having the ground fault.

17. The PV power system of claim 16 wherein the controller is further programmed to:
identify the ground fault from sampled current data from the current sensor provided on the ground conductor; and
locate the ground fault using sampled current data from at least one of a current sensor coupled to a positive conductor and a current sensor coupled to a negative conductor.

18. The PV power system of claim 17 wherein the controller is further programmed to locate the ground fault using sampled current data from current sensors coupled to a plurality of positive conductors and a plurality of negative conductors.

19. The PV power system of claim 16 wherein the controller is further programmed to:
compare a current measurement from a current sensor on a positive conductor of a given channel of the combiner to a current measurement from a current sensor on a negative conductor of the given channel of the combiner;
identify a ground fault within a PV array corresponding to the given channel of the combiner if the difference between the current measurements exceeds a predefined current threshold.

20. The PV power system of claim 16 wherein the controller is further programmed to:
calculate a ratio of a change in positive current data to a change in negative current data sampled from the PV array having the ground fault; and
identify a location of the ground fault within the PV array from the ratio.
